(19) United States
(12) Patent Application Publication
(10) Pub. No.: US 2002/0129230 A1
(43) Pub. Date: Sep. 12, 2002

(54) Method, System, and program for determining system configuration information

(75) Inventors: Michaelj D. Albright, Longmont, CO (US); William B. DeRolf, Layfayette, CO (US); Gavin G. Gibson, Westminster, CO (US); Gavin J. Kirton, Erie, CO (US); Todd H. McKenney, Broomfield, CO (US)

Correspondence Address: KONRAD RAYNES VICTOR & MANN, LLP, 315 SOUTH BEVERLY DRIVE, SUITE 210, BEVERLY HILLS, CA, 90212, US

(73) Assignee: Sun Microsystems, Inc.

(21) Appl. No.: 09/802,229

(22) Filed: Mar. 8, 2001

(51) Int. Cl. G06F 15/177; G06F 9/00; G06F 9/24

(52) U.S. Cl. 713/1

(57) ABSTRACT

Provided is a computer implemented method, system, and program for determining system information, wherein the system is comprised of at least one host adaptor, switch, and storage device. A path in the system from one host adaptor to the I/O device includes as path components one host adaptor, one switch, one storage device, a first link between the host adaptor and the switch and a second link between the switch and the storage device. A determination is made of component information on host adaptor, switch, and I/O device components in a network system. The determined component information is added to a configuration file providing configuration information on the system. For each determined host adaptor, a determination is made from the component information of information on the first link between the host adaptor and the switch and on the I/O device to which the host adaptor communicates. The determined information on the first link and the I/O device to which the host adaptor communicates is then used to determine the second link between the I/O device and the switch. The information on the first and second link is added to the configuration file.

### BACKGROUND OF THE INVENTION

1. Field of the Invention

The present invention relates to a method, system, and program for determining system configuration information.

2. Description of the Related Art

A storage area network (SAN) comprises a network linking one or more servers to one or more storage systems. Each storage system could comprise a Redundant Array of Independent Disks (RAID) array, tape backup, tape library, CD-ROM library, or JBOD (Just a Bunch of Disks) components. Storage area networks (SAN) typically use the Fibre Channel Arbitrated Loop (FC-AL) protocol, which uses optical fibers to connect devices and provide high bandwidth communication between the devices. In Fibre Channel terms the “fabric” comprises one or more switches, such as cascading switches, that connect the devices. The link is the two unidirectional fibers, which may comprise an optical wire, transmitting to opposite directions with their associated transmitter and receiver. Each fiber is attached to a transmitter of a port at one end and a receiver of another port at the other end. When a fabric is present in the configuration, the fiber may attach a node port (N_Port) to a port of a switch in the Fabric (F_Port).

A Fibre Channel storage area network (SAN) often comprises an amalgamation of numerous hosts, workstations, and storage devices from different vendors. One difficulty administrators have is maintaining information on the configuration of the entire SAN. Each vendor may provide a configuration tool to probe the vendor devices, e.g., host adaptors, switches, storage devices on the network. In the prior art, the administrator would have to separately invoke each vendor's configuration tool to determine information on the vendor components in the SAN. After separately obtaining information on the components in the SAN, the administrator would then have to analyze the information to determine the SAN configuration and interrelationship of the devices, i.e., how the host adaptors, switches and storage devices are connected.

The above prior art process for ascertaining the configuration of a SAN has many problems. First, is that determination of the configuration depends on the efforts of a human administrator to integrate the system information generated from different vendor configuration tools. This is problematic because the administrator may incorrectly determine the configuration by misinterpreting the data. Further, if the configuration mapped by the administrator is no longer available or outdated due to alterations of the SAN, then the entire analytical process must be performed again. Still further, diagnostic tools or other software tools may want to use information on the SAN configuration. Because the configuration is mapped by a human administrator, interested programs must query the administrator for configuration questions.

For all the above reasons there is a need in the art for an improved technique for ascertaining a SAN configuration.

### SUMMARY OF THE DESCRIBED IMPLEMENTATIONS

Provided is a computer implemented method, system, and program for determining system information, wherein the system is comprised of at least one host adaptor, switch, and I/O device. A path in the system from one host adaptor to the I/O device includes as path components one host adaptor, one switch, one I/O device, a first link between the host adaptor and the switch and a second link between the switch and the VO device . A determination is made of component information on host adaptor, switch, and I/O device components in a network system. The determined component information is added to a configuration file providing configuration information on the system. For each determined host adaptor, a determination is made from the component information on the first link between the host adaptor and the switch and on the I/O device to which the host adaptor communicates. A determination is further made of the second link between the I/O device and the switch. The information on the first and second link is added to the configuration file.

In further implementations, the second link is determined by using the determined information on the first link and I/O device to which the host adaptor communicates.

In further implementations, a request is received from an application program for configuration information on at least one component m the system. The configuration file is queried to determine the requested configuration information. The requested configuration information is then returned to the application program.

Still further, the component information includes the address of each component in the system, such as a Fiber Channel Arbitrated Loop Physical Address (AL_PA), world wide name (WWN), serial number, etc..

In yet further implementations, the switch is comprised of multiple initiator and destination ports. In such case, the component information indicates the address of each initiator and destination port in the switch. The information on the first link indicates the initiator port on the switch to which the host adaptor connects and the information on the second link indicates the destination port on the switch to which the I/O device connects. At least one path includes one destination port and initiator port in the switch.

### BRIEF DESCRIPTION OF THE DRAWINGS

Referring now to the drawings in which like reference numbers represent corresponding parts throughout:

FIG. 1 illustrates a network computing environment in which preferred embodiments may be implemented;

FIG. 2 illustrates an implementation of a configuration discovery tool in accordance with certain implementations of the invention; and

FIGS. 3-5 illustrate logic implemented in the configuration discovery tool to determine the configuration of a network system in accordance with certain implementations of the invention.

### DETAILED DESCRIPTION OF THE PREFERRED EMBODIMENTS

In the following description, reference is made to the accompanying drawings which form a part hereof and which illustrate several embodiments of the present invention. It is understood that other embodiments may be utilized and structural and operational changes may be made without departing from the scope of the present invention.

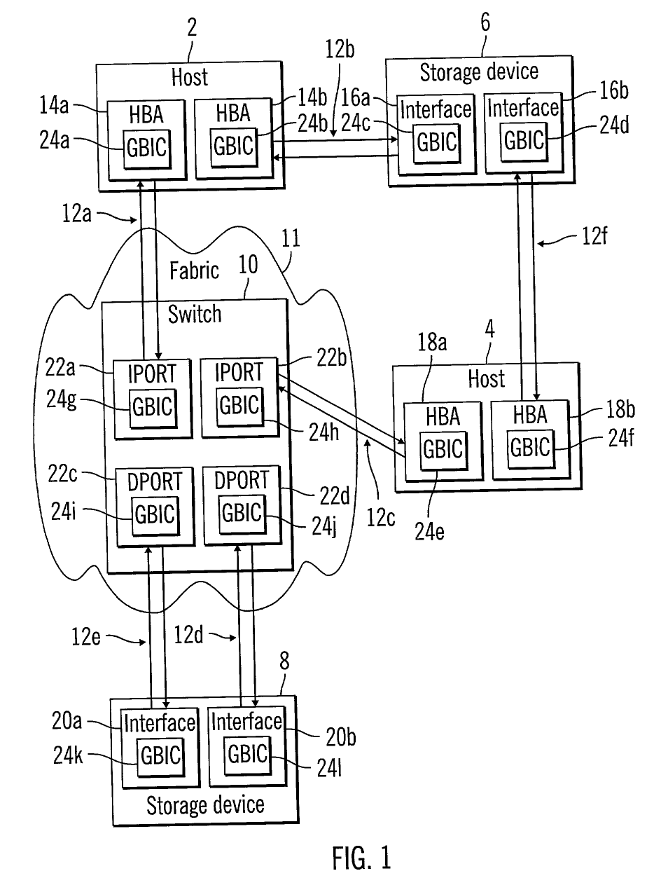

FIG. 1 illustrates an example of a storage area network (SAN) topology utilizing Fibre Channel protocols which may be discovered by the described implementations. Host computers 2 and 4 may comprise any computer system that is capable of submitting an Input/Output (I/O) request, such as a workstation, desktop computer, server, mainframe, laptop computer, handheld computer, telephony device, etc. The host computers 2 and 4 would submit I/O requests to storage devices 6 and 8. The storage devices 6 and 8 may comprise any storage device known in the art, such as a JBOD Oust a bunch of disks), a RAID array, tape library, storage subsystem, etc. A switch 10 connects the attached devices 2, 4, and 8. One or more switches, such as cascading switches, would comprise a Fibre Channel fabric 11. In the described implementations, the links 12a, b, c, d, e, f connecting the devices comprise Fibre Channel Arbitrated Loops or fiber wires. In alternative implementations, the different components of the system may comprise any network communication technology known in the art. Each device 2, 4, 6, 8, and 10 includes multiple Fibre Channel interfaces 14a, 14b, 16a, 16b, 18a, 18b, 20a, 20b, 22a, b, c, d, also referred to as a port, device or host bus adaptor (HBA), and a Gigabyte Interface Converter Modules (GBIC) 24a-1. The GBICs 24a-1 convert optical signals to electrical signals. The fibers 12a, b, c, d, e, f; interfaces 14a, b, 16a, b, 18a, b, 20a, b, 22a, b, c, d; and GBICs 24a-1 comprise individually replaceable components, or field replaceable units (FRUs). The components of the storage area network (SAN) described above would also include additional FRUs. For instance, the storage devices 6 and 8 may include hot-swapable disk drives, controllers, power/cooling units, or any other replaceable components. For instance, the Sun Microsystems A5×00 storage array has an optical interface and includes a GBIC to convert the optical signals to electrical signals that can be processed by the storage array controller. The Sun Microsystems T3 storage array includes an electrical interface and includes a media interface adaptor (MIA) to convert electrical signals to optical signals to transfer over the fiber.**

A path, as that term is used herein, refers to all the components providing a connection from a host to a storage device. For instance, a path may comprise host adaptor port 14a, fiber 12a, initiator port 22a, device port 22c, fiber 12e, device interface 20a, and the storage devices or disks being accessed. The path may also comprise a direct connection, such as the case with the path from host adaptor 14b through fiber 12b to interface 16a.

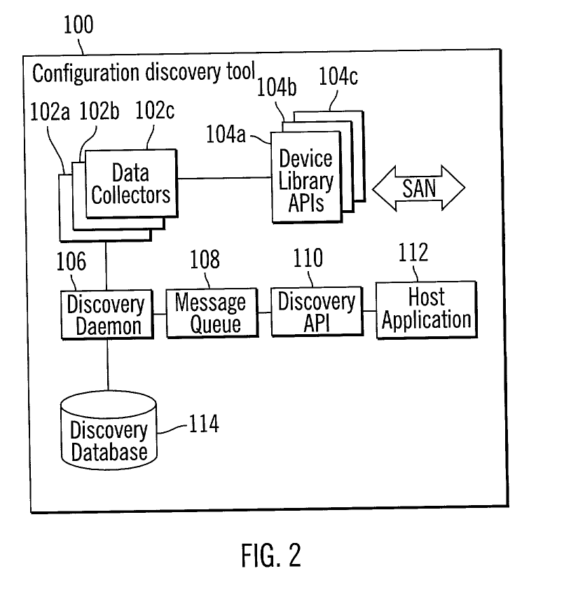

FIG. 2 illustrates an implementation of the software architecture of a configuration discovery tool 100 that is capable of determining the configuration of a SAN system. In one implementation, the configuration discovery tool 100 comprises a software program executed within the hosts 2, 4. The configuration discovery tool 100 includes a plurality of data collectors 102a, b, c; device library application program interfaces (APIs) 104a, b, c; a discovery daemon 106; a message queue 108; a discovery API 110; host application 112; and a discovery database 114.

The data collectors 102a, b, c comprise program modules that detect the presence of a particular component in the SAN, such as the SAN shown in FIG. 1. A data collector 102a, b, c would be provided for each specific vendor component capable of residing in the system, such as a host adaptor 14a, b, switches in the fabric 10, storage device 6, 8. Each data collector 102a, b, c calls vendor and component specific device library APIs 104a, b, c to perform the configuration detection operations, wherein there is a device library API 104a, b, c for each vendor component that may be included in the SAN. The data collector 102a, b, c would use the APIs provided by the device vendor, including the vendor APIs in the device library 104a, b, c, to query each instance of the vendor component in the SAN for configuration information. As discussed, in the prior art, vendors provide APIs and device drivers to access and detect information on their devices. The preferred implementations utilize the vendor specific APIs to obtain information on a particular vendor device in the system. The data gathered by the data collectors 102a, b, c may then be used to provide a topological configuration view of the SAN. The system configuration information gathered by the data collectors 102a, b, c is written to the discovery database 114.

The discovery daemon 106 detects messages from a host application 112 requesting system configuration information that are placed in the message queue 108. The discovery daemon 106 monitors the message queue 108 and services requests for system configuration information from the discovery database 114 or by calling the data collectors 102a, b, c to gather the configuration information. The host application 112 may use discovery API 110 to request particular configuration information, such as the configuration of the host bus adaptors 14a, b, 18a, b, storage devices 6, 8, and switches 10 in the fabric 11.

The discovery database 114 resident on each host 2, 4 includes configuration information on each host bus adaptor (HBA) 14a, b, 18a, b storage device interface 16a, b, 20a, b and switch ports 22a, b, c, d on the host system.

For each host adaptor node 14a, b, 18a, b or port, the discovery database 114 would include:

Logical Path: The logical path of the host bus adaptor 14a, b, 18a, b in the SAN.

Physical Path: The physical path of the host adaptor node.

Node World Wide Name (WWN): provides a unique identifier assigned to a host adaptor port (node) 14a, b, 18a, b.

Port World Wide Name: unique world wide name (WWN) assigned to the host port from which the host adaptor port 14a, b, 18a, b communicates to identify the host adaptor port 14a, b, 18a, b.

Arbitrated Loop Physical Address: Provides an arbitrated loop physical address (AL_PA) of the host adaptor (HBA) if the HBA is attached to an arbitrated loop.

Product Information: General product information for a component would include the device type (e.g., adaptor, switch, storage device, etc.), vendor name, vendor identifier, host adaptor product name, firmware version, serial number, device version number, name of driver that supports device, etc.

The discovery database 114 would maintain the following information for each switch port, i.e., IPORTs 22a, b, DPORTs 22c, d, in each switch 10 in the fabric 11. Thus, if a switch 10 had 8 ports, then the information for such switch 10 in the fabric 11 may include eight instances of the following information:

Product Information Would indicate that the device is a switch, and provide the product information for the switch 10.

Fabric IP Address: Transmission Control Protocol/Intemet Protocol (TCPI/IP) address of the switch 10. This Fabric IP address may be used for out-of-band communication with the switch 10.

Fabric Name: IP name of the switch 10 in the fabric 11.

Switch Device Count: Number of Fiber Channel Arbitrated Loop (FC-AL) devices connected to the switch 10 port. In a FC-AL configuration, there is a loop comprised of a fiber link that interconnects a limited number of other devices or systems.

Switch WWN: Provides the world wide number (WWN) unique identifier of the switch 10.

Max Ports: total number of ports on the switch 10.

Port Number: Port number of port node on switch 10.

Device Arbitrated Loop Addresses: For destination ports (DPORTs) 22c, d provides a list of arbitrated loop physical addresses (AL_PA) of all devices connected to arbitrated loop to which switch 10 port is attached.

Node World Wide Name (WWN): World wide name (WWN) identifier of a switch port 22a, b, c, d. For IPORTs 22a, b, the WWN is the WWN of the host adaptor port 14a, 18a linked to the IPORT 22a, b. For DPORTs 22c, d, the WWN is the WWN name of the host adaptor port 14a, 18a, connected to the IPORT 22a, b in the path of the DPORT 22c, d.

Parent: identifier of parent component, such as world wide number or unique identifier of component immediately upstream of the switch port. The immediate upstream component can comprise another switch port. For instance, the parent of one of the device ports (DPORT) 22c, d comprises one of the initiator ports (IPORT) 22a, b. Further, the immediate upstream component or parent of the initiator ports 22a, b comprises one of the host adaptor ports 14a, 18a. In certain implementations, the IPORT may have a unique identifier assigned. In additional implementations, the unique identifier of the IPORT 22a, b may be the world wide name (WWN) and the Fibre Channel arbitrated loop physical address (AL_PA) of the host adaptor ports 14a, 18a connected to the IPORT 22a, b. In the described implementations, the links 12a, b, c, d, e, f connecting the components comprise Fibre Channel arbitrated loops.

Parent Type: Type of parent device, e.g., host adaptor, switch, disk subsystem, etc.

The discovery database 114 would also maintain configuration information for each attached storage device 6, 8. A logical path, physical path, node world wide number, port world wide number, and product information, described above, would be provided for each storage device 6, 8. The discovery database 114 would further maintain for each storage device, a device type field indicating the type of the device, i.e., storage device 6, 8, and a parent field providing the unique identifier of the destination port (DPORT) 24c, d to which the storage device 8 interface 20a, b is connected. In the case where there is no switch 10 in the path, the parent field for the storage device 6, 8 comprises the host adaptor ports 14a, 18a.

When providing information on each port within one of the components, e.g., host 2, 4, switch 10, storage device 6, 8, the discovery database 114 may repeat the general component information with the port information, or have separate parts of the component information for the enclosure including the parts, as well as information on each port.

In addition to providing detailed information on each individual component in the SAN, the interrelationship of the SAN components can be ascertained from the parent information in the discovery database 114. The parent field in the discovery database 114 indicates how the components relate to each other. Because each node in the system has a parent (except the first node, which in the above implementation is the HBA port) indicating the connecting upstream node, the parent information associates each node with one other node. A set of nodes including interconnecting parents defines a path from one host adaptor to a storage device.

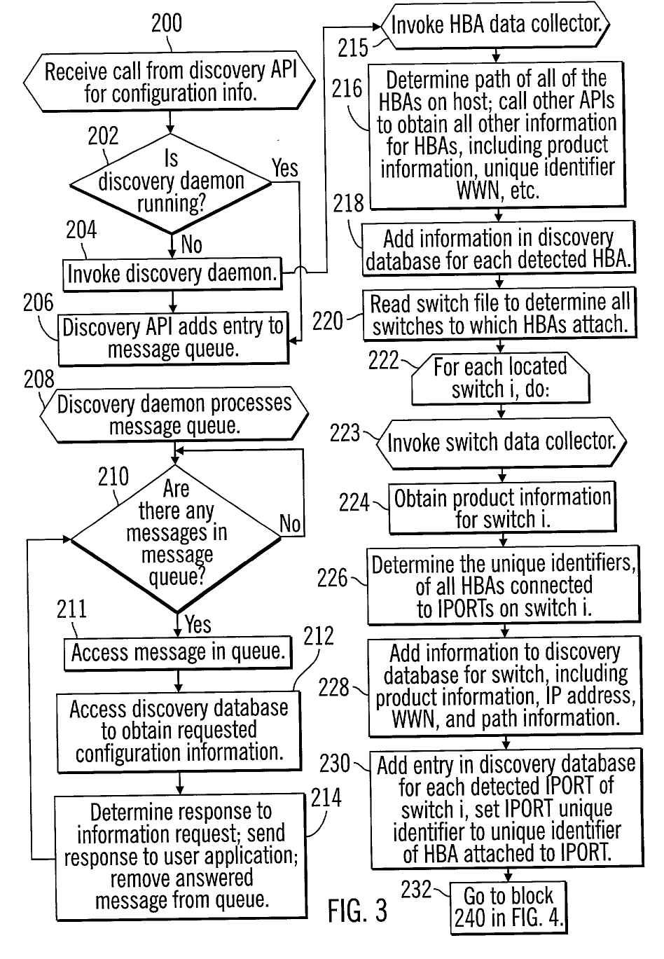

FIGS. 3-5 illustrate logic implemented in the configuration discovery tool 100, executing within the hosts 2, 4, that determines the configuration of the SAN, including the interrelationship of the system components, e.g., host adaptors, switches, and storage devices. With respect to FIG. 3, control begins at block 200 with the host 2, 4, receiving a call to a discovery API 110 from the host application 112. The received discovery API 110 call includes a request for system configuration information, the HBA to which the disk is connected, the switch to which a disk is attached, switches attached to the host, etc If (at block 202) the discovery daemon 106 is not running, then the discovery daemon is invoked (at block 204). Upon invoking the discovery daemon 106, the discovery API adds (at block 206) an entry for the message to the message queue and further invokes (at block 215) the HBA data collector 102a, b, c to gather information on the host adaptors (HBAs) in the host 2, 4 invoking the configuration discovery tool 100. If (at block 202) the discovery daemon 106 is running, then control proceeds to block 206 to add the message to the message queue.

At block 208, the discovery daemon 106 processes the message queue 108. If (at block 210) there are no pending messages in the queue 108, then control loops back to keep monitoring the queue for messages. Otherwise, if (at block 210) there are pending messages, then the discovery daemon 106 accesses (at block 211) one message from the queue 108 and accesses (at block 212) the discovery database 114 to obtain the requested information. The discovery daemon 106 then determines (at block 214) from the discovery database 114 the requested configuration information, returns the requested information to the host application 112 issuing the discovery API 110 call, and removes the answered message from the message queue 108.

If (at block 202) the discovery daemon 106 is not running, then the discovery daemon 106 is invoked (at block 215), which starts the host adaptor data collector 102a, b, c to gather information on the host adaptors (HBAs) in the host 2, 4 invoking the configuration discovery tool 100. The host adaptor data collector 102a, b or c would then perform steps 216 and 218 to gather information on all host adaptors included in the host 2, 4. If the host 2, 4 invoking the configuration discovery tool 100 is capable of having host adaptors from multiple vendors, then the data collector for each host adaptor vendor would be called to use vendor specific device drivers to gather information on the vendor host adaptors in the host 2, 4 invoking the discovery tool 100. The host adaptor data collector 102a, b or c then determines (at block 216) the path of all host adaptor ports 14a, b, 18a, b in the host 2, 4. The host adaptor data collector 102a, b or c would further call additional device driver APIs in the device library APIs 104a, b, c to obtain all the other information on the host adaptors for the discovery database 114, such as the product information, world wide name (WWN) and arbitrated loop physical address (AL_PA) of host the adaptor. The gathered information on the host adaptors is then added (at block 218) to the discovery database 114.

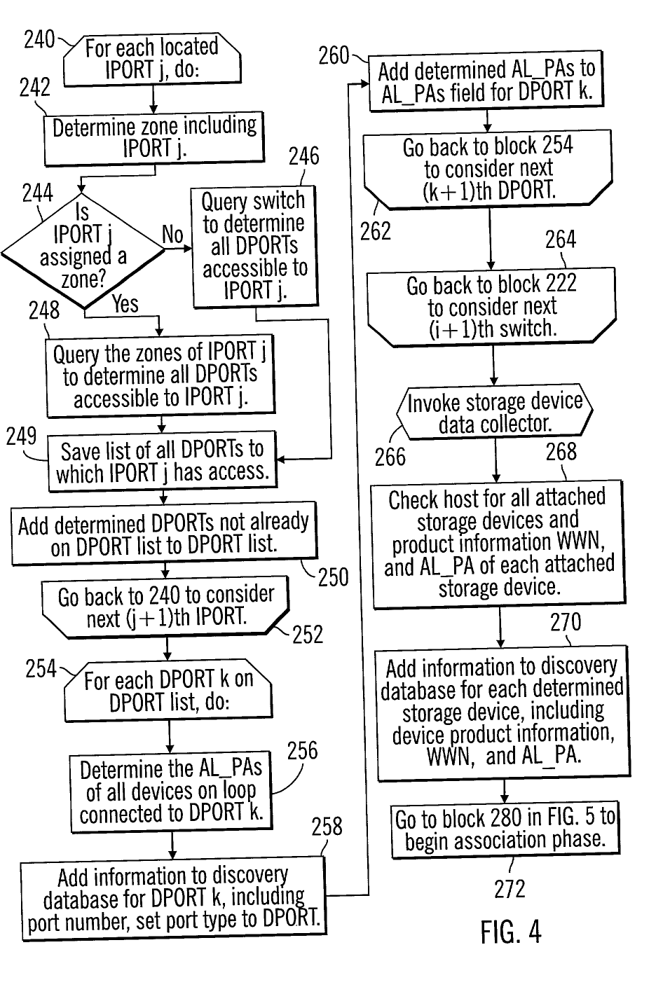

A switch file in the host 2, 4 is then read (at block 220) to determine all switches to which the host adaptors (HBAs) connect. For each determined switch i indicated in the host switch file, a loop is performed at blocks 222 through 264 to call (at block 223) the switch data collector 102a, b, c for switch i. If the SAN is capable of including switches from different vendors, then the vendor specific data collector 102a, b, c would be used to gather and update the discovery database 114 with the switch infornation. In certain implementations, the switch data collector 102a, b, c, executing in the host 2, 4 invoking the discovery tool 100, communicates with the switch i to gather information through an out-of-band connection with respect to the fiber link 12a, 12c, such as through a separate Ethernet card using an IP address of the switch i. In such implementations, the host switch file would further specify the IP addresses for each switch to allow for out-of-band communication. The called switch data collector 102a, b, c queries switch i to obtain (at block 224) product information. The switch data collector 102a, b, c further queries (at block 226) the switch i to determine the unique identifier, e.g., world wide name (WWN) and arbitrated loop physical address (AL_PA), of each host bus adaptor 14a, 18a attached to the switch 10. The switch data collector 102a, b, c then adds (at block 228) the gathered information for the switch i in general to the discovery database 114, including the product information, IP address of the switch i for out-of-band communication, the switch i world wide number (WWN), arbitrated loop physical address (AL_PA), and path information. The switch data collector 102a, b, c then adds (at block 230) information to the discovery database 114 for each detected initiator port (IPORT) 22a, b on the switch, and sets the unique identifier, e.g., world wide name (WWN) and AL_PA, for the detected IPORT 22a, b to the unique identifier, e.g., WWN and AL_PA, of the host bus adaptor (HBA) 14a, 18a connected to that IPORT. Control then proceeds (at block 232) to block 240 in FIG. 4.

With respect to FIG. 4, the switch i data collector 102a, b, c performs a loop at blocks 240 and 252 for each initiator port (IPORT)j to detect all destination ports (DPORTs) 24c, d on the switch. At block 242, the switch i data collector 102a, b, c queries the switch i to determine all zones in the switch i associated with the IPORTj. In Fibre Channel switches, the switch may be divided into zones that define the ports that may communicate with each other to provide more efficient and secure communication among functionally grouped nodes. If (at block 244) the IPORT j is not assigned to a zone, then the IPORT j can communicate with all DPORTs 24c, d on the switch i. In such case, the switch data collector 102a, b, c queries (at block 244) switch i to determine DPORTs accessible to IPORT j. If (at block 242) IPORTj is assigned to a zone in switch i, then a query is issued (at block 248) to the switch i to determine all the DPORTs in the zone associated with IPORT j. A list of all the DPORTs to which IPORTj has access is then saved (at block 249). Further, all the determined DPORTs are also added (at block 250) to a DPORT list including all DPORTs on the switch i.

If there are further IPORTs to consider, then control proceeds (at block 252) to the next (j+1)th IPORT. If all IPORTs have been considered, then a loop is performed at blocks 254 to 262 for each DPORT k on the DPORT list to determine all the arbitrated loop physical addresses (AL_PA) on the loop to which each destination port (DPORT) is attached. At block 256, the switch i data collector 102a, b, c queries the switch i to determine the arbitrated loop physical addresses (AL_PA) of all devices attached to the fiber loop to which DPORT k connects. The determined AL_PA addresses are added (at block 258) to the discovery database 114 for DPORT k, including the port number, port type, i.e., DPORT. Further, all the determined AL_PAs are added (at block 260) to the AL_PA field for DPORT k. Control then proceeds (at block 262) back to block 254 to consider the next DPORT on the DPORT list. At this point, information on all the components of the switch i, are added to the discovery database 114. Accordingly, control then proceeds (at block 264) back to block 222 to consider the next (i+1)th switch.

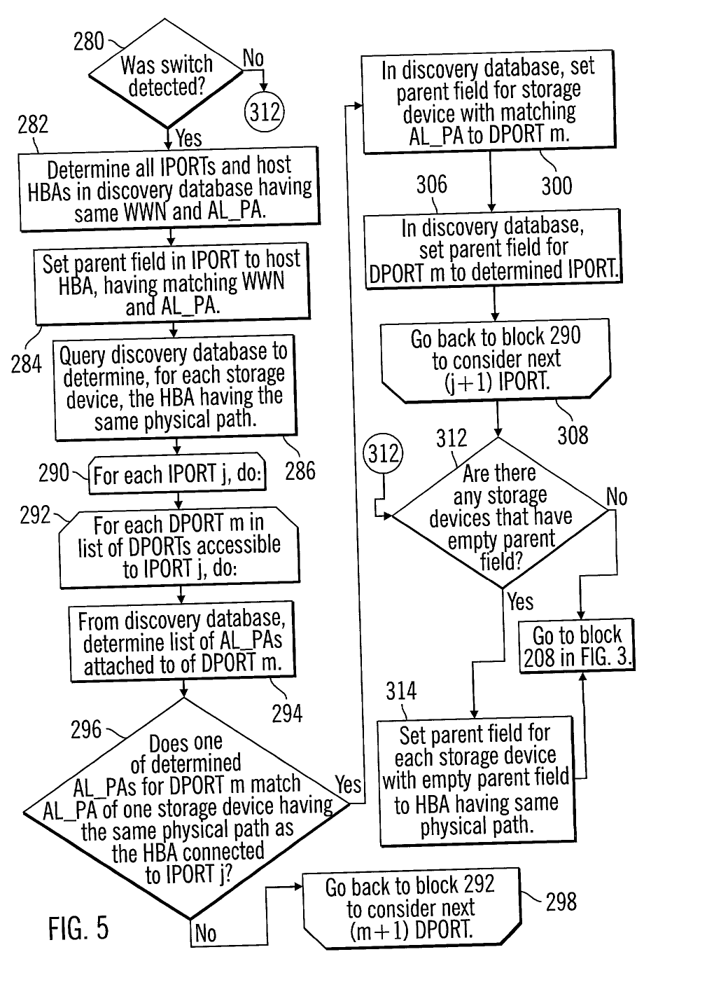

If there are no further switches to consider, then the storage device data collector 102a, b, c is called (at block 266) to gather and add storage device information to the discovery database 114. The host 2, 4 may communicate with the storage devices 6, 8 via an out-of-band communication line, such as through Ethernet interfaces over a Local Area Network (LAN). The storage device data collector 102a, b, c queries information in the host 2, 4 using the device library APIs 104a, b, c to determine (at block 268) the product information, IP address, world wide name (WWN), arbitrated loop physical address (AL_PA) for all attached storage devices 6, 8. The storage device data collector 102a, b, c then adds (at block 270) the determined information to the discovery database 114 for each connected storage device 6, 8. Control then proceeds (at block 272) to block 280 in FIG. 5 to determine the interrelationship of the components and the parent information.

At block 270 in FIG. 4, the discovery database 114 has information on all the host bus adaptors (HBAs) 14a, b, 18a, b in the host from which the configuration discovery tool 100 is invoked, all switches attached to the host 2, 4, and all storage devices 6, 8 to which the host may communicate. Thus, information on the individual components in the SAN are known from the perspective of one host 2, 4.

With respect to FIG. 5, if (at block 280), the discovery daemon 106, or some other program module, such as one of the data collectors 102a, b, c, determines (at block 280) if a switch was detected. If so, then the discovery daemon 106 determines (at block 282) all initiator ports (IPORTs) and host HBAs having a matching unique identifier, e.g., world wide name (WWN) and AL_PA, indicating an IPORT and connected HBA. The parent field in each IPORT is set (at block 284) to the host HBA having the matching unique identifier, e.g., WWN and AL_PA. The discovery daemon 106 then queries (at block 286) the discovery database 114 to determine for each storage device, the HBA having a matching physical address, indicating the storage device 6, 8 to which the HBA 14a, 18a connects through the switch 10. At this point, the host HBA 14a, 18a 2, 4, IPORT, 22a, b and storage device 6, 8 for one path are known. The DPORTs in the path can be obtained from the determined information. A loop is performed at block 290 to 308 to determine the IPORT parent for each DPORT m in the DPORT list built at block 250 in FIG. 4.

For each IPORT j, a nested loop is performed from blocks 292 through 308 for each DPORT m in the list of DPORTs accessible to IPORT j. For each DPORT m accessible to IPORT j, the discovery daemon 106 determines from the discovery database 114 the list of all arbitrated loop physical addresses (AL_PA) on the loop to which the DPORT m connects, e.g., fibers 12e, d. If (at block 296) one of the AL_PAs on the loop to which the DPORT m connects matches the AL_PA of one of the storage devices having the same physical path as the host adaptor connected to IPORT j, which was determined at block 286, then the DPORT m provides the portion of the path from the switch 10 to the storage device 6, 8 for initiator j and the host adaptor having the same physical path address. In such case, the parent field for the storage device 6, 8 in the discovery database 114 is set (at block 300) to the unique identifier, e.g., world wide name (WWN) and AL_PA of DPORT m. A determination is further made (at block 302) from the discovery database 114 of the host adaptor ports 14a, 18a having the same physical path as the storage device 6, 8 whose parent is DPORT m and that is also connected to IPORT j as determined at block 296. The parent field in the discovery database 114 for DPORT m is set (at block 306) to the IPORT j whose parent is the determined host bus adaptor 14a having the same physical path as the storage device whose parent is DPORT m. Control then proceeds (at block 308) back to block 290 to consider the next (j+1)th IPORT.

After information on all the host adaptors and storage devices that communicate through a switch and their interrelationship has been added to the discovery database 114, then control proceeds to block 312 to add information to the discovery database 114 for those host bus adaptors 14b, 18b that communicate directly with a storage device 6. If (at block 312) there are any storage devices 6 that have empty parent fields, then such storage devices do not connect through a switch 10 because the parent information indicating the interrelationship of switched components was previously determined. In such case, the parent field for each storage device 6 with the empty parent field is set (at block 314) to the unique identifier, which may be the world wide name (WWN) and AL_PA, of the host adaptor port 14b, 18b having the same physical path.

The information in the parent fields provides information to identify all the components that form a distinct path through the switch 10 from the HBA 14a, 18a to the storage device 8. After all the information on the SAN components and their interrelationship has been added to the discovery database 114, control returns to block 208 where the discovery daemon 106 can start processing discovery requests pending in the message queue 108.

After the configuration information is within the discovery database 114, the information may be outputted in human readable format. For instance, a program could generate the information for each device in the SAN. Altematively, another program could process the discovery database 114 information to provide an illustration of the configuration using the interrelationship information provided in the parent fields for each system component

The above described configuration discovery tool implementation provides a technique for automatically using the API drivers from the vendors of different components that may exist in the SAN to consistently and automatically access information on all the system components, e.g., host bus adaptors, switches, storage devices and automatically determine the interrelationship of all the components. With this tool, system administrators do not have to themselves map out the topology of the SAN network through separately invoking the device drivers for each system component. Instead, with the configuration discovery tool, provides an automatic determination of the topology in response to requests from host applications for information on the topology.

What follows are some alternative implementations for the preferred embodiments.

The described implementation of the configuration discovery tool 100 may be implemented as a method, apparatus or article of manufacture using standard programming and/or engineering techniques to produce software, firmware, hardware, or any combination thereof The term “article of manufacture” as used herein refers to code or logic implemented in hardware logic (e.g., an integrated circuit chip, Field Programmable Gate Array (FPGA), Application Specific Integrated Circuit (ASIC), etc.) or a computer readable medium (e.g., magnetic storage medium (e.g., hard disk drives, floppy disks,, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which preferred embodiments of the configuration discovery tool are implemented may futher be accessible through a transmission media or from a file server over a network. In such cases, the article of manufacture in which the code is implemented may comprise a transmission media, such as a network transmission line, wireless transmission media, signals propagating through space, radio waves, infrared signals, etc. Of course, those skilled in the art will recognize that many modifications may be made to this configuration without departing from the scope of the present invention, and that the article of manufacture may comprise any information bearing medium known in the art.

In the described implementations, certain operations were described as performed by the data collectors 102a, b, c and others the discovery daemon 106. However, operations described as performed by the data collectors 102a, b, c may be performed by the discovery daemon 106 or some other program module. Similarly, operations described as performed by the discovery daemon 106 may be performed by the data collectors 102a, b, or some other program module.

FIG. 2 described an implementation of the software architecture for the configuration discovery tool. Those skilled in the art will appreciate that different software architectures may be used to implement the discovery configuration tool described herein.

The described implementations referenced storage systems including GBICs, fabrics, and other SAN related components. In alternative embodiments, the storage system may comprise more or different types of replaceable units than those mentioned in the described implementations.

In the described implementations, the determined configuration information provided paths from a host to a storage device. Additionally, if each storage device includes different disk devices that are accessible through different interface ports 16a, b 20a, b, then the configuration may further include the disk devices, such that the parent field for one disk device within the storage device 6, 8 enclosure is the DPORT 22c, d in the switch 10 or one host 2, 4 if there is no switch 10.

In the described implementations, the storage devices tested comprised hard disk drive storage units. Additionally, the tested storage devices may comprise tape systems, optical disk systems or any other storage system known in the art. Still further, the configuration discovery tool may apply to storage networks using protocols other than the Fibre Channel protocol.

In the described implementations, each component was identified with a unique identifier, such as world wide name (WWN) and arbitrated loop physical address (AL_PA). In alternative implementations, alternative identification or address information may be used. Further, if the component is not connected to an arbitrated loop, then there may be no AL_PA used to identify the component. Moreover, if the component is attached to a loop that is not a Fibre Channel loop than alternative loop address information may be provided. Still further, additional addresses may also be used to identify each component in the system.

In the described implementations the configuration determined was a SAN system. Additionally, the configuration discovery tool of the invention may be used to determine the configuration of systems including input/output (I/O) devices other than storage devices including an adaptor or interface for network communication, such that the described testing techniques can be applied to any network of I/O devices, not just storage systems.

In the described embodiments, the configuration discovery tool is executed from one host system. Additionally, the discovery tool may be initiated from another device in the system.

If multiple hosts in the SAN run the configuration discovery tool, then each host would maintain its own discovery database 114 providing the view of the architecture with respect to that particular host. Alternatively, a single discovery database 114 may be maintained on a network location accessible to other systems.

In the described implementations, the tested system included only one switch between a host and storage device. In additional implementations, there may be multiple switches between the host and target storage device.

In the described implementations, the switch providing paths between the hosts and storage devices includes a configuration of initiator and destination ports. In alternative implementations, the switch may have alternative switch configurations known in the art, such as a hub, spoke, wheel, etc.

The foregoing description of various implementations of the invention has been presented for the purposes of illustration and description. It is not intended to be exhaustive or to limit the invention to the precise form disclosed. Many modifications and variations are possible in light of the above teaching. It is intended that the scope of the invention be limited not by this detailed description, but rather by the claims appended hereto. The above specification, examples and data provide a complete description of the manufacture and use of the composition of the invention. Since many embodiments of the invention can be made without departing from the spirit and scope of the invention, the invention resides in the claims hereinafter appended.

**STOREDGE, SUN, SUN MICROSYSTEMS, T3, and A5—00 are trademarks of Sun Microsystems, Inc.

What is claimed is:

1. A computer implemented method for determining system information, wherein the system is comprised of at least one host adaptor, at least one switch, and at least one Input/Output (I/O) device, wherein a path in the system from one host adaptor to the I/O device includes as path components one host adaptor, one switch, one storage device, a first link between the host adaptor and the switch and a second link between the switch and the storage device, comprising:
determining component information on host adaptor, switch, and I/O device components in a network system;
adding the determined component information to a configuration file providing configuration information on the network system;
for each detemined host adaptor, performing:
(i) determining, from the component information, information on the first link between the host adaptor and the switch;
(ii) determining, from the component information, information on the I/O device to which the host adaptor communicates;
(iii) determining the second link between the I/O device and the switch; and
(iv) adding information on the first and second link to the configuration file.

2. The method of claim 1, wherein the second link is determined by using the determined information on the first link and the I/O device to which the host adaptor communicates.

3. The method of claim 1, further comprising:
receiving a request from an application program for configuration information on at least one component in the system;
querying the configuration file to determine the requested configuration information; and
returning the requested configuration information to the application program.

4. The method of claim 1, wherein the component information includes the address of each component in the system.

5. The method of claim 4, wherein the component information includes a loop address of each I/O device connecting to a loop that also connects to the switch, wherein the component information further includes information on multiple loops to which the switch connects and for each loop, the address of all the devices that are attached to the loop, wherein determining the second link further comprises:
determining one I/O device having a loop address that matches the loop address of one device attached to the loop to which the switch connects, wherein the second link includes the loop to which the determined I/O device and switch connect.

6. The method of claim 5, wherein the switch includes multiple destination ports and initiator ports, wherein the initiator ports connect to host adaptors and the destination ports connect to storage devices, wherein the first link includes the initiator port and wherein the second link includes the destination port.

7. The method of claim 4, wherein the switch is comprised of multiple initiator and destination ports, wherein the component information indicates the address of each initiator and destination port in the switch, wherein the information on the first link indicates the initiator port on the switch to which the host adaptor connects and wherein the information on the second link indicates the destination port on the switch to which the I/O device connects, wherein at least one path includes one destination port and initiator port in the switch.

8. The method of claim 7, wherein the address of each initiator port comprises the address of the host adaptor connected to the initiator port, wherein determining the first link further comprises:
determining the host adaptor having the same address as the address of one initiator port, wherein the first link comprises a connection between the host adaptor and initiator port having the same address.

9. The method of claim 7, wherein a plurality of destination ports connect to loops, wherein a plurality of devices are capable of being attached to the loop and wherein each attached device and the destination port have a loop address on the loop, wherein a plurality of I/O devices connect to the loops, wherein the component information indicates the loop address of the I/O devices connected to the loops, and wherein determining the second link further comprises:
for each initiator port, performing:
determining one destination port the initiator port is capable of accessing; and
determining one I/O device having a loop address that matches the loop address of one of the devices attached to the loop to which the determined destination port is attached, wherein the second link includes the loop to which the determined I/O device and determined destination port are attached.

10. The method of claim 9, wherein the component information includes a physical path address for each host adaptor and I/O device, wherein the address of each initiator port comprises the address of the host adaptor connected to the initiator port, further comprising:
determining the host adaptor having the same address as the address of one initiator port, wherein the first link comprises a connection between the host adaptor and initiator port having the same address; and
determining one I/O device having a same physical path address as the determined host adaptor, wherein the determined host adaptor transfers data to the I/O device having the same physical path address, wherein the component information associates the destination port with the initiator port having the same address as the host adaptor that has the same physical path address as the I/O device to which the destination port connects.

11. The method of claim 7, wherein the switch implements the Fibre Channel protocol.

12. The method of claim 1, wherein the I/O device comprises a storage device.

13. A system for determining network information, wherein the network is comprised of at least one host adaptor, at least one switch, and at least one Input/Output (I/O) device, wherein a path in the network from one host adaptor to the I/O device includes as path components one host adaptor, one switch, one storage device, a first link between the host adaptor and the switch and a second link between the switch and the storage device, comprising:
means for determining component information on host adaptor, switch, and I/O device components in the network;
means for adding the determined component information to a configuration file providing configuration information on the network system;
means for performing, for each determined host adaptor:
(i) determining, from the component information, information on the first link between the host adaptor and the switch;
(ii) determining, from the component information, information on the I/O device to which the host adaptor communicates;
(iii) determining the second link between the I/O device and the switch; and
(iv) adding information on the first and second link to the configuration file.

14. The system of claim 13, wherein the second link is determined by using the determined information on the first link and the I/O device to which the host adaptor communicates.

15. The system of claim 13, further comprising:
means for receiving a request from an application program for configuration information on at least one component in the system;
means for querying the configuration file to determine the requested configuration information; and
means for returning the requested configuration information to the application program.

16. The system of claim 13, wherein the component information includes the address of each component in the system.

17. The system of claim 16, wherein the component information includes a loop address of each I/O device connecting to a loop that also connects to the switch, wherein the component information further includes information on multiple loops to which the switch connects and for each loop, the address of all the devices that are attached to the loop, wherein the means for determining the second link further performs:
determining one I/O device having a loop address that matches the loop address of one device attached to the loop to which the switch connects, wherein the second link includes the loop to which the determined I/O device and switch connect.

18. The system of claim 17, wherein the switch includes multiple destination ports and initiator ports, wherein the initiator ports connect to host adaptors and the destination ports connect to storage devices, wherein the first link includes the initiator port and wherein the second link includes the destination port.

19. The system of claim 16, wherein the switch is comprised of multiple initiator and destination ports, wherein the component information indicates the address of each initiator and destination port in the switch, wherein the information on the first link indicates the initiator port on the switch to which the host adaptor connects and wherein the information on the second link indicates the destination port on the switch to which the I/O device connects, wherein at least one path includes one destination port and initiator port in the switch.

20. The system of claim 19, wherein the address of each initiator port comprises the address of the host adaptor connected to the initiator port, wherein the means for determining the first link further performs:
determining the host adaptor having the same address as the address of one initiator port, wherein the first link comprises a connection between the host adaptor and initiator port having the same address.

21. The system of claim 19, wherein a plurality of destination ports connect to loops, wherein a plurality of devices are capable of being attached to the loop and wherein each attached device and the destination port have a loop address on the loop, wherein a plurality of I/O devices connect to the loops, wherein the component information indicates the loop address of the I/O devices connected to the loops, and wherein the means for determining the second link further performs for each initiator port:
determining one destination port the initiator port is capable of accessing; and
determining one I/O device having a loop address that matches the loop address of one of the devices attached to the loop to which the determined destination port is attached, wherein the second link includes the loop to which the determined I/O device and determined destination port are attached.

22. The system of claim 21, wherein the component information includes a physical path address for each host adaptor and I/O device, wherein the address of each initiator port comprises the address of the host adaptor connected to the initiator port, further comprising:
means for determining the host adaptor having the same address as the address of one initiator port, wherein the first link comprises a connection between the host adaptor and initiator port having the same address; and
means for determining one I/O device having a same physical path address as the determined host adaptor, wherein the determined host adaptor transfers data to the I/O device having the same physical path address, wherein the component information associates the destination port with the initiator port having the same address as the host adaptor that has the same physical path address as the I/O device to which the destination port connects.

23. The system of claim 19, wherein the switch implements the Fibre Channel protocol.

24. The system of claim 13, wherein the I/O device comprises a storage device.

25. An article of manufacture implementing code to determine system information, wherein the system is comprised of at least one host adaptor, at least one switch, and at least one Input/Output (I/O) device, wherein a path in the system from one host adaptor to the I/O device includes as path components one host adaptor, one switch, one storage device, a first link between the host adaptor and the switch and a second link between the switch and the storage device, by:
determining component information on host adaptor, switch, and I/O device components in a network system;
adding the determined component information to a configuration file providing configuration information on the network system;
for each determined host adaptor, performing:
(i) determining, from the component information, information on the first link between the host adaptor and the switch;
(ii) determining, from the component information, information on the I/O device to which the host adaptor communicates;
(iii) determining the second link between the I/O device and the switch; and
(iv) adding information on the first and second link to the configuration file.

26. The article of manufacture of claim 25, wherein the second link is determined by using the determined information on the first link and the I/O device to which the host adaptor communicates.

27. The article of manufacture of claim 25, further comprising:
receiving a request from an application program for configuration information on at least one component in the system;
querying the configuration file to determine the requested configuration information; and
returning the requested configuration information to the application program.

28. The article of manufacture of claim 25, wherein the component information includes the address of each component in the system.

29. The article of manufacture of claim 28, wherein the component information includes a loop address of each I/O device connecting to a loop that also connects to the switch, wherein the component information further includes information on multiple loops to which the switch connects and for each loop, the address of all the devices that are attached to the loop, wherein determining the second link further comprises:
determining one I/O device having a loop address that matches the loop address of one device attached to the loop to which the switch connects, wherein the second link includes the loop to which the determined I/O device and switch connect.

30. The article of manufacture of claim 29, wherein the switch includes multiple destination ports and initiator ports, wherein the initiator ports connect to host adaptors and the destination ports connect to storage devices, wherein the first link includes the initiator port and wherein the second link includes the destination port.

31. The article of manufacture of claim 28, wherein the switch is comprised of multiple initiator and destination ports, wherein the component information indicates the address of each initiator and destination port in the switch, wherein the information on the first link indicates the initiator port on the switch to which the host adaptor connects and wherein the information on the second link indicates the destination port on the switch to which the I/O device connects, wherein at least one path includes one destination port and initiator port in the switch.

32. The article of manufacture of claim 31, wherein the address of each initiator port comprises the address of the host adaptor connected to the initiator port, wherein determining the first link further comprises:
determining the host adaptor having the same address as the address of one initiator port, wherein the first link comprises a connection between the host adaptor and initiator port having the same address.

33. The article of manufacture of claim 31, wherein a plurality of destination ports connect to loops, wherein a plurality of devices are capable of being attached to the loop and wherein each attached device and the destination port have a loop address on the loop, wherein a plurality of I/O devices connect to the loops, wherein the component information indicates the loop address of the I/O devices connected to the loops, and wherein determining the second link further comprises:
for each initiator port, performing:
determining one destination port the initiator port is capable of accessing; and
determining one I/O device having a loop address that matches the loop address of one of the devices attached to the loop to which the determined destination port is attached, wherein the second link includes the loop to which the determined I/O device and determined destination port are attached.

34. The article of manufacture of claim 33, wherein the component information includes a physical path address for each host adaptor and I/O device, wherein the address of each initiator port comprises the address of the host adaptor connected to the initiator port, further comprising:
determining the host adaptor having the same address as the address of one initiator port, wherein the first link comprises a connection between the host adaptor and initiator port having the same address; and
determining one I/O device having a same physical path address as the determined host adaptor, wherein the determined host adaptor transfers data to the I/O device having the same physical path address, wherein the component information associates the destination port with the initiator port having the same address as the host adaptor that has the same physical path address as the I/O device to which the destination port connects.

35. The article of manufacture of claim 31, wherein the switch implements the Fibre Channel protocol.

36. The article of manufacture of claim 25, wherein the I/O device comprises a storage device.
